(19) United States
(12) Patent Application Publication
(10) Pub. No.: US 2020/0099050 A1
(43) Pub. Date: Mar. 26, 2020

(54) POSITIVE ELECTRODE FOR NON-AQUEOUS ELECTROLYTE SECONDARY BATTERY AND NON-AQUEOUS ELECTROLYTE SECONDARY BATTERY

(71) Applicant: Panasonic Intellectual Property Management Co., Ltd., Osaka-shi, Osaka (JP)

(72) Inventors: Takaya Tochio, Osaka (JP); Kaoru Nagata, Osaka (JP); Takeshi Ogasawara, Hyogo (JP)

(73) Assignee: Panasonic Intellectual Property Management Co., Ltd., Osaka-shi, Osaka (JP)

(21) Appl. No.: 16/472,512

(22) PCT Filed: Dec. 18, 2017
(86) PCT No.: PCT/JP2017/045239

§ 371 Date: Jun. 21, 2019

(30) Foreign Application Priority Data
Dec. 28, 2016 (JP) 2016-256407

(51) Int. Cl. H01M 4/525; H01M 4/131; H01M 4/62; H01M 10/0525

(52) U.S. Cl. CPC H01M 4/525; H01M 4/131; H01M 2004/028; H01M 10/0525; H01M 4/62

(57) ABSTRACT

A positive electrode for a non-aqueous electrolyte secondary battery contains a first particle and a second particle. The first particle is an electrochemically active positive-electrode active material, and the positive-electrode active material contains a lithium transition metal oxide. The second particle is an electrochemically inactive metal oxide and has a BET specific surface area in the range of 10 to 100 m²/g and a sphericity of 0.8 or more.

### TECHNICAL FIELD

The present invention relates primarily to an improvement in a positive electrode of a non-aqueous electrolyte secondary battery.

### BACKGROUND ART

In recent years, non-aqueous electrolyte secondary batteries, particularly lithium-ion secondary batteries, have been expected as power supplies for small-scale consumer applications, power storage apparatuses, and electric vehicles due to their high voltages and high energy densities.

A positive-electrode active material for a non-aqueous electrolyte secondary battery is a lithium transition metal oxide containing Ni, Co, and Al, for example (see Patent Literature 1).

### CITATION LIST

### Patent Literature

PTL 1: Japanese Published Unexamined Patent Application No. 8-213015

### SUMMARY OF INVENTION

### Solution to Problem

An alkaline component used in the synthesis of a lithium transition metal oxide may remain on the surface of the lithium transition metal oxide. The alkaline component reacts with ambient water and carbon dioxide and produces lithium carbonate, for example. The product, such as lithium carbonate, decomposes and produces carbon dioxide during charging and discharging and during high-temperature storage of the non-aqueous electrolyte secondary battery. In particular, in lithium transition metal oxides containing Ni as a main component, an alkaline component tends to remain and produce carbon gas. An increase in carbon gas evolution results in defects, such as expansion of the battery.

In view of such situations, a positive electrode for a non-aqueous electrolyte secondary battery according to one aspect of the present disclosure contains a first particle and a second particle. The first particle is an electrochemically active positive-electrode active material, and the positive-electrode active material contains a lithium transition metal oxide. The second particle is an electrochemically inactive metal oxide and has a BET specific surface area in the range of 10 to 100 m²/g and a sphericity of 0.8 or more.

A non-aqueous electrolyte secondary battery according to another aspect of the present disclosure includes the positive electrode, a negative electrode, and a non-aqueous electrolyte.

The present disclosure can provide a positive electrode that can decrease gas evolution during charging and discharging and during high-temperature storage of a non-aqueous electrolyte secondary battery.

### BRIEF DESCRIPTION OF DRAWINGS

FIG. 1 is a schematic partly cutaway perspective view of a non-aqueous electrolyte secondary battery according to an embodiment of the present invention.

### DESCRIPTION OF EMBODIMENTS

A positive electrode for a non-aqueous electrolyte secondary battery according to an embodiment of the present invention contains a first particle and a second particle. The first particle is an electrochemically active positive-electrode active material, and the positive-electrode active material contains a lithium transition metal oxide. The second particle is an electrochemically inactive metal oxide. Inactive metal oxides not contributing to a charge-discharge reaction are almost free of alkaline components.

The second particle has a BET specific surface area in the range of 10 to 100 m²/g and a sphericity of 0.8 or more. Such a second particle is porous and has pores with a size appropriate to incorporate an alkaline component into the pores (for example, with an average pore size in the range of 10 to 100 nm). In such a second particle, a portion of the second particle exposed to the outside has a relatively small surface area, and the interior (pores) of the second particle has a relatively large surface area.

The second particle can easily incorporate an alkaline component remaining on the surface of the first particle into the interior (pores) of the second particle. Incorporation of an alkaline component into the second particle can decrease gas evolution during charging and discharging and during high-temperature storage.

When the second particle has a BET specific surface area of less than 10 m²/g, the interior (pores) of the second particle has a small surface area, and the second particle has insufficient pores with an appropriate size. Thus, the second particle incorporates a smaller amount of alkaline component.

When the second particle has a BET specific surface area of more than 100 m²/g, the second particle has fewer pores in its interior, and the particle surface exposed to the outside makes a greater contribution. Thus, the second particle incorporates a smaller amount of alkaline component into the interior (pores). This also sometimes makes it difficult to control the viscosity of a positive electrode slurry used in the preparation of the positive electrode.

Even if the second particle has a BET specific surface area in the range of 10 to 100 m²/g, when the second particle has a sphericity of less than 0.8, the second particle has a complex shape. Thus, the second particle has fewer pores in its interior, and the particle surface exposed to the outside makes a greater contribution. Thus, the second particle incorporates a smaller amount of alkaline component into the interior (pores).

To further decrease gas evolution, the second particle preferably has a BET specific surface area in the range of 40 to 75 m²/g and a sphericity of 0.9 or more.

The sphericity of the second particle is represented by 47πS/Lₐ² (wherein S denotes the area of the orthogonal projection image of the second particle, and Lₐ denotes the perimeter of the orthogonal projection image of the second particle). The sphericity of the second particle can be measured, for example, by the image processing of a scanning electron microscope (SEM) photograph of the second particle. The sphericities of randomly selected 100 particles are averaged.

Examples of the lithium transition metal oxide of the first particle include LiₐCoO₂, LiₐNiO₂, LiₐMnO₂, LiₐCo_{b}Ni_{1-b}O₂, LiₐCo_{b}M_{1-b}O_{c}, LiₐNi_{1-b}M_{b}O_{c}, LiₐMn₂O₄, LiₐMn_{2-b}M_{b}O₄, LiMePO₄, and Li₂MePO₄F. M denotes at least one selected from the group consisting of Na, Mg, Sc, Y, Mn, Fe, Co, Ni, Cu, Zn, Al, Cr, Pb, Sb, and B. Me includes at least a transition element (for example, at least one selected from the group consisting of Mn, Fe, Co, and Ni). a=0 to 1.2, b=0 to 0.9, and c=2.0 to 2.3. The mole ratio a of lithium is the value immediately after the production of the active material and increases or decreases by charging and discharging.

To increase the capacity, the lithium transition metal oxide preferably contains Ni. However, an alkaline component tends to remain on a lithium transition metal oxide containing Ni. This enhances the effect of the second particle incorporating an alkaline component.

Among lithium transition metal oxides containing Ni, LiₐNiₓCo_{y}Al_{z}O₂ (0≤a≤1.2, 0.8≤x<1.0, 0<y≤0.2, 0<z≤0.1, x+y+z=1) is preferred. Ni with x of 0.8 or more can increase the capacity. Co with y of 0.2 or less can increase the crystal structure stability of the lithium transition metal oxide while maintaining high capacity. Al with z of 0.1 or less can increase the thermal stability of the lithium transition metal oxide while maintaining the output characteristics.

The metal oxide of the second particle is preferably an oxide that is a raw material of the first particle. In this case, the lithium transition metal oxide of the first particle and the metal oxide of the second particle contain the same transition metal as a main component. Like the lithium transition metal oxide of the first particle, the metal oxide of the second particle contains at least one selected from the group consisting of Ni, Co, Mn, Al, Ti, Fe, Mo, W, Cu, Zn, Sn, Ta, V, Zr, Nb, Mg, Ga, In, La, and Ce, for example. Among these, the metal oxide preferably contains Ni, more preferably Ni, Co, and Al.

When the first particle and the second particle contain the same transition metal with the same chemical properties as a main component, an alkaline component can move from the first particle to the second particle without blockage, and the second particle can easily incorporate the alkaline component. Furthermore, the use of a raw material of the first particle suppresses side reactions in the battery and tends to stabilize charge-discharge characteristics.

The phrase “a metal oxide contains a transition metal as a main component” means that the fraction (mole fraction) of the transition metal in the metal oxide is the highest of the fractions of metallic elements in the metal oxide. The phrase “a lithium transition metal oxide contains a transition metal as a main component” means that the fraction (mole fraction) of the transition metal in the lithium transition metal oxide is the highest of the fractions of metallic elements other than lithium contained in the lithium transition metal oxide.

The positive electrode preferably contains a mixture of the first particles and the second particles. In the positive electrode, preferably, the first particles and the second particles are almost uniformly dispersed and are mixed together. The second particles appropriately placed around the first particles can efficiently incorporate an alkaline component remaining on the surface of the first particles.

The average particle size P1 of the first particles and the average particle size P2 of the second particles preferably satisfy the relational expression:

0.8≤P2/P1≤1.2

When P2/P1 is within this range, the first particles and the second particles are easily mixed together, and the second particles appropriately placed around the first particles can efficiently incorporate an alkaline component remaining on the surface of the first particles.

The first particles preferably have an average particle size in the range of 2 to 30 μm. When the first particles have an average particle size of 2 μm or more, the first particles (positive-electrode active material) do not have an excessively large specific surface area, and the alkaline component is prevented from being eluted. The first particles with an average particle size of 30 μm or less can have a sufficiently increased utilization rate of the first particles (positive-electrode active material).

The second particles preferably have an average particle size in the range of 2 to 35 μm. When the second particles have an average particle size in this range, the first particles and the second particles are easily uniformly mixed together, and the second particles can efficiently incorporate an alkaline component remaining on the surface of the first particles. Each average particle size of the first particles and the second particles is the median size in the particle size distribution on a volume basis.

The positive electrode preferably contains 0.03 to 0.3 parts by mass of the second particles per 100 parts by mass of the first particles. When the second particle content of the positive electrode is 0.03 parts or more by mass per 100 parts by mass of the first particles, the second particles can have a sufficiently enhanced effect of incorporating an alkaline component. When the second particle content of the positive electrode is more than 0.3 parts by mass per 100 parts by mass of the first particles, however, the capacity may be decreased. The second particle content of the positive electrode can be low and therefore has no influence on the loading weight (positive-electrode capacity) of the positive-electrode active material (first particles) in the positive electrode.

A mixture of the first particles and the second particles can be prepared, for example, by mixing the second particles with a dispersion medium to prepare a dispersion liquid, adding the first particles to the dispersion liquid, and then drying the mixture. The dispersion medium is water, for example.

When the second particles are formed of a metal oxide, the second particles can be produced, for example, by the following method.

Aqueous sodium hydroxide is added dropwise to an aqueous solution (for example, aqueous sulfuric acid) containing a predetermined metallic element while stirring, thereby forming a precipitate. The precipitate is removed by filtration, is washed, and is dried. The precipitate is then ground to prepare a metal hydroxide containing a predetermined metallic element. The metal hydroxide is fired in the air or in an oxygen atmosphere under predetermined conditions (first firing) to prepare a metal oxide (second particles). The first firing temperature ranges from 500° C. to 1200° C., for example. The first firing time ranges from 10 to 24 hours, for example.

The sphericity of the second particles can be controlled by changing the stirring speed in the formation of the precipitate, for example. The BET specific surface area of the second particles can be controlled, for example, by changing the stirring speed and the firing temperature in the formation of the precipitate.

The type and component ratio of metallic elements in the metal oxide of the second particles are preferably the same as the type and component ratio of metallic elements other than lithium contained in the lithium transition metal oxide (first particles). In this case, the metal oxide of the second particles can also be used in the synthesis of the lithium transition metal oxide (the formation of the first particles). This is advantageous in terms of productivity. The P2/P1 ratio of the average particle size P2 of the second particles to the average particle size P1 of the first particles can be easily adjusted in the range of 0.8 to 1.2.

When the type and component ratio of metallic elements in the metal oxide of the second particles are the same as the type and component ratio of metallic elements other than lithium contained in the lithium transition metal oxide (first particles), the first particles can be formed by the following method, for example.

Lithium hydroxide, lithium carbonate, or lithium oxide is added to the metal oxide (second particles) to prepare a mixture. The first firing temperature of the second particles preferably ranges from 500° C. to 800° C. The mixture is fired in an oxygen atmosphere under predetermined conditions (second firing) to prepare the lithium transition metal oxide (first particles). The second firing temperature ranges from 500° C. to 850° C., for example. The second firing time ranges from 10 to 24 hours, for example. After the second firing, the first particles may be washed with water and dried.

A non-aqueous electrolyte secondary battery according to an embodiment of the present invention will be described below. The non-aqueous electrolyte secondary battery includes a positive electrode, a negative electrode, and a non-aqueous electrolyte.

### [Positive Electrode]

The positive electrode includes a positive-electrode current collector and a positive-electrode mixture layer formed on the surface of the positive-electrode current collector, for example. The positive-electrode mixture layer can be formed by applying a positive electrode slurry, which contains a positive-electrode mixture dispersed in a dispersion medium, to the surface of the positive-electrode current collector and drying the positive electrode slurry. The dried film may be rolled, if necessary. The positive-electrode mixture layer may be formed on one or both surfaces of the positive-electrode current collector.

The positive-electrode mixture contains, as essential components, the first particles (positive-electrode active material), the second particles (metal oxide, etc.), and a binder, and can contain an electrically conductive agent and/or a thickener as an optional component.

Examples of the binder include resin materials, for example, fluoropolymers, such as polytetrafluoroethylene and poly(vinylidene difluoride) (PVDF); polyolefin resins, such as polyethylene and polypropylene; polyamide resins, such as aramid resins; polyimide resins, such as polyimides and polyamideimides; acrylic resins, such as poly(acrylic acid), poly(methyl acrylate), and ethylene-acrylic acid copolymers; vinyl resins, such as polyacrylonitrile and poly(vinyl acetate); polyvinylpyrrolidone; polyethersulfone; and rubber materials, such as styrene-butadiene copolymer rubber (SBR). These may be used alone or in combination.

Examples of the electrically conductive agent include graphite, such as natural graphite and artificial graphite; carbon black, such as acetylene black; electrically conductive fibers, such as carbon fibers and metal fibers; fluorocarbons; metal powders, such as aluminum; electrically conductive whiskers, such as zinc oxide and potassium titanate; electrically conductive metal oxides, such as titanium oxide; and electrically conductive organic materials, such as phenylene derivatives. These may be used alone or in combination.

Examples of the thickener include cellulose derivatives such as, carboxymethylcellulose (CMC), modified products thereof (including salts, such as Na salts), and methylcellulose (cellulose ethers, etc.); saponified products of polymers having a vinyl acetate unit, such as poly(vinyl alcohol); and polyethers (poly(alkylene oxide)s, such as poly(ethylene oxide), etc.). These may be used alone or in combination.

The positive-electrode current collector may be a nonporous electrically conductive substrate (metal foil, etc.) or a porous electrically conductive substrate (mesh, net, punching sheet, etc.). The material of the positive-electrode current collector is stainless steel, aluminum, an aluminum alloy, or titanium, for example. The positive-electrode current collector may have any thickness, for example, in the range of 3 to 50 μm.

Examples of the dispersion medium include, but are not limited to, water, alcohols, such as ethanol, ethers, such as tetrahydrofuran, amides, such as dimethylformamide, N-methyl-2-pyrrolidone (NMP), and mixed solvents thereof.

### [Negative Electrode]

The negative electrode includes a negative-electrode current collector and a negative-electrode mixture layer formed on the surface of the negative-electrode current collector, for example. The negative-electrode mixture layer can be formed by applying a negative electrode slurry, which contains a negative-electrode mixture dispersed in a dispersion medium, to the surface of the negative-electrode current collector and drying the negative electrode slurry. The dried film may be rolled, if necessary. The negative-electrode mixture layer may be formed on one or both surfaces of the negative-electrode current collector.

The negative-electrode mixture contains a negative-electrode active material as an essential component and can contain a binder, an electrically conductive agent, and/or a thickener as an optional component.

For example, the negative-electrode active material contains a carbon material that electrochemically adsorbs and desorbs lithium ions. Examples of the carbon material include graphite, easily graphitizable carbon (soft carbon), and non-graphitizable carbon (hard carbon). Among these, graphite is preferred due to its high charge-discharge stability and low irreversible capacity. Graphite means a material with a graphite crystal structure and includes natural graphite, artificial graphite, and graphitized mesophase carbon particles, for example. These carbon materials may be used alone or in combination.

The negative-electrode current collector may be a nonporous electrically conductive substrate (metal foil, etc.) or a porous electrically conductive substrate (mesh, net, punching sheet, etc.). The material of the negative-electrode current collector is stainless steel, nickel, a nickel alloy, copper, or a copper alloy, for example. The thickness of the negative-electrode current collector is preferably, but not limited to, in the range of 1 to 50 μm, more preferably 5 to 20 μm, from the perspective of the balance between the strength and weight reduction of the negative electrode.

The binder, thickener, and dispersion medium may be those exemplified for the positive electrode. The electrically conductive agent may be those exemplified for the positive electrode except graphite.

### [Non-Aqueous Electrolyte]

The non-aqueous electrolyte contains a non-aqueous solvent and a lithium salt dissolved in the non-aqueous solvent. The concentration of lithium salt in the non-aqueous electrolyte ranges from 0.5 to 2 mol/L, for example. The non-aqueous electrolyte may contain a known additive agent.

Examples of the non-aqueous solvent include cyclic carbonates, chain carbonates, and cyclic carboxylates. The cyclic carbonate may be propylene carbonate (PC) or ethylene carbonate (EC). The linear carbonate may be diethyl carbonate (DEC), ethyl methyl carbonate (EMC), or dimethyl carbonate (DMC). The cyclic carboxylate may be γ-butyrolactone (GBL) or γ-valerolactone (GVL). These non-aqueous solvents may be used alone or in combination.

Examples of the lithium salt include lithium salts of chlorine-containing acids (LiClO₄, LiAlCl₄, LiB₁₀Cl₁₀, etc.), lithium salts of fluorine-containing acids (LiPF₆, LiBF₄, LiSbF₆, LiAsF₆, LiCF₃SO₃, LiCF₃CO₂, etc.), lithium salts of fluorine-containing acid imides (LiN(CF₃SO₂)₂, LiN(CF₃SO₂)(C₄F₉SO₂), LiN(C₂F₅SO₂)₂, etc.), and lithium halides (LiCl, LiBr, LiI, etc.). These lithium salts may be used alone or in combination.

### [Separator]

It is usually desirable that a separator be disposed between the positive electrode and the negative electrode. The separator has high ion permeability and appropriate mechanical strength and insulating properties. The separator may be a microporous thin film, woven fabric, or nonwoven fabric. The material of the separator is preferably a polyolefin, such as polypropylene or polyethylene.

A non-aqueous electrolyte secondary battery according to an embodiment includes an electrode assembly and a non-aqueous electrolyte in a housing. The electrode assembly includes a roll of a positive electrode and a negative electrode with a separator interposed therebetween. Alternatively, another electrode assembly, such as a layered electrode assembly, may be used instead of the wound electrode assembly. The layered electrode assembly includes a positive electrode and a negative electrode stacked with a separator interposed therebetween. The non-aqueous electrolyte secondary battery may be of any type, for example, of a cylindrical, square or rectangular, coin, button, or laminate type.

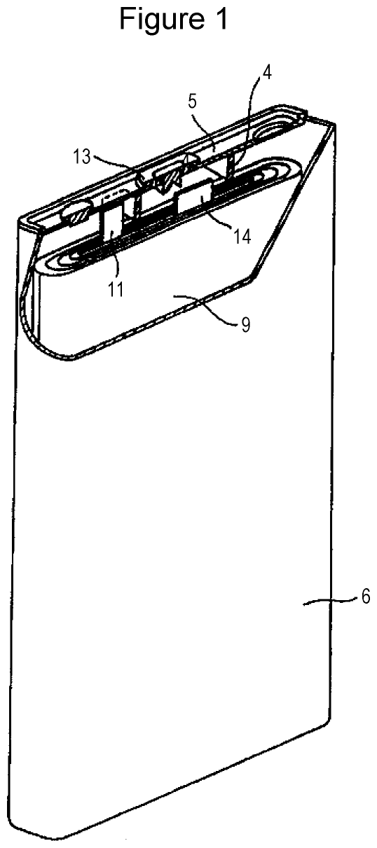

FIG. 1 is a schematic partly cutaway perspective view of a rectangular non-aqueous electrolyte secondary battery according to an embodiment of the present invention.

The battery includes a closed-end rectangular battery case 6, an electrode assembly 9 housed in the battery case 6, and a non-aqueous electrolyte (not shown). The electrode assembly 9 includes a long belt-like negative electrode, a long belt-like positive electrode, and a separator, which is disposed between the negative electrode and the positive electrode and prevents the direct contact between the negative electrode and the positive electrode. The electrode assembly 9 is formed by winding the negative electrode, the positive electrode, and the separator around a flat core and removing the core.

The negative-electrode current collector in the negative electrode is attached to one end of a negative-electrode lead 11, for example, by welding. The positive-electrode current collector in the positive electrode is attached to one end of a positive-electrode lead 14, for example, by welding. The other end of the negative-electrode lead 11 is electrically connected to a negative-electrode terminal 13 disposed on a sealing plate 5. The other end of the positive-electrode lead 14 is electrically connected to the battery case 6, which also serves as a positive-electrode terminal. A resin frame 4 for isolating the electrode assembly 9 from the sealing plate 5 and isolating the negative-electrode lead 11 from the battery case 6 is disposed on the top of the electrode assembly 9. The opening of the battery case 6 is sealed with the sealing plate 5.

### EXAMPLES

Although the present invention will be more specifically described with the following examples and comparative examples, the present invention should not be limited to the examples.

### Example 1

### [Preparation of Second Particles]

Nickel sulfate hexahydrate (NiSO₄.6H₂O), cobalt sulfate heptahydrate (CoSO₄.7H₂O), and aluminum sulfate hexadecahydrate (Al₂(SO₄)₃.16H₂O) were mixed at a Ni, Co, and Al atomic ratio of 0.91:0.06:0.03 and were dissolved in water. Aqueous sodium hydroxide was then added dropwise to the aqueous solution of the mixture while stirring at a predetermined stirring speed to form a precipitate. The precipitate was removed by filtration, was washed, and was dried. The precipitate was then ground to prepare a metal hydroxide (Ni_{0.91}Co_{0.06}Al_{0.03}(OH)₂) with an average particle size of approximately 10 μm. The metal hydroxide was fired in an oxygen atmosphere at 600° C. for 12 hours to prepare a metal oxide (Ni_{0.91}Co_{0.06}Al_{0.03}O) (second particles) with an average particle size of approximately 10 μm.

### [Preparation of First Particles]

Lithium hydroxide was added to the metal oxide (Ni_{0.91}Co_{0.06}Al_{0.03}O) (second particles), and the metal oxide was then fired in an oxygen atmosphere at 700° C. for 12 hours. In this manner, a lithium transition metal oxide (LiNi_{0.91}CO_{0.06}Al_{0.03}O₂) (first particles) with an average particle size of approximately 10 μm was produced.

### [Preparation of Mixture of First Particles and Second Particles]

The second particles were dispersed in water to prepare a dispersion liquid of the second particles. The first particles (positive-electrode active material) were added to the dispersion liquid and were stirred. The mixture of the first particles and the second particles was then removed by filtration and was dried. The amount of the second particles was 0.03 parts by mass per 100 parts by mass of the first particles.

### [Preparation of Positive Electrode]

A mixture of the first particles and the second particles, acetylene black, and poly(vinylidene difluoride) were mixed at a mass ratio of 95:2.5:2.5. After the addition of N-methyl-2-pyrrolidone (NMP), the mixture was stirred with a mixer (T.K. Hivis Mix manufactured by Primix Corporation) to prepare a positive electrode slurry. The positive electrode slurry was then applied to the surface of aluminum foil, was dried, and was rolled to form a positive electrode that had a positive-electrode mixture layer with a density of 3.6 g/cm³ on both sides of the aluminum foil.

### [Preparation of Negative Electrode]

A graphite powder (average particle size: 20 μm), sodium carboxymethylcellulose (CMC-Na), and styrene-butadiene rubber (SBR) were mixed at a mass ratio of 97.5:1:1.5. After the addition of water, the mixture was stirred with a mixer (T.K. Hivis Mix manufactured by Primix Corporation) to prepare a negative electrode slurry. The negative electrode slurry was then applied to the surface of copper foil, was dried, and was rolled to form a negative electrode that had a negative-electrode mixture layer with a density of 1.5 g/cm³ on both sides of the copper foil.

### [Preparation of Non-aqueous Electrolytic Solution]

LiPF₆ was dissolved at a concentration of 1.0 mol/L in a mixed solvent containing ethylene carbonate (EC) and diethyl carbonate (DEC) at a volume ratio of 3:7, thus preparing a non-aqueous electrolytic solution.

### [Manufacture of Non-aqueous Electrolyte Secondary Battery]

A tab was attached to each of the electrodes. The positive electrode and the negative electrode were wound with the separator interposed therebetween such that the tabs were located on the outermost periphery, thus forming an electrode assembly. The separator was a microporous polyethylene film 20 μm in thickness. The electrode assembly was inserted into an aluminum laminated film housing and was dried under vacuum at 105° C. for 2 hours. A non-aqueous electrolytic solution was poured into the housing, and the opening of the housing was sealed. Thus, a non-aqueous electrolyte secondary battery was completed.

### Comparative Example 1

A non-aqueous electrolyte secondary battery was manufactured in the same manner as in Example 1 except that the mixture of the first particles and the second particles was replaced with the first particles alone in the preparation of the positive electrode.

### Examples 2 to 5 and Comparative Examples 2 to 5

In the production of the second particles, the sphericity of the second particles was varied as shown in Table 1 by changing the stirring speed when aqueous sodium hydroxide was added dropwise to form a precipitate. In the production of the second particles, the specific surface area of the second particles was varied as shown in Table 1 by changing the sodium hydroxide concentration and the stirring speed when aqueous sodium hydroxide was added dropwise to form a precipitate and by changing the firing temperature when the metal hydroxide was fired.

Except for these, non-aqueous electrolyte secondary batteries were manufactured in the same manner as in Example 1.

The batteries according to the examples and comparative examples and the second particles used in the positive electrode of each battery were subjected to the following evaluation.

### [Evaluation]

### (A) Measurement of Sphericity of Second Particles

The sphericity of the second particles was determined by the image processing of a scanning electron microscope (SEM) photograph of the second particles. The sphericities of randomly selected 100 particles were averaged.

### (B) Measurement of Specific Surface Area of Second Particles

The specific surface area of the second particles was measured by the BET method.

(C) Measurement of Amount of Gas Evolution during High-Temperature Storage

In each battery, constant-current charging at an electric current of 1.0 It (800 mA) to a voltage of 4.2 V was followed by constant-voltage charging at a voltage of 4.2 V to an electric current of 1/20 It (40 mA). Each battery after charging was left to stand at 85° C. for 12 hours.

The density of each battery after charging (before left to stand) and after left to stand was measured by the Archimedes' principle, and the amount of gas evolution was determined from the amount of change in the density of the battery.

Table 1 shows the evaluation results.

TABLE 1

| | Specific surface | Sphericity | Amount |
|---|---|---|---|
| | area of second | of second | of gas |
| | particle (m²/g) | particle | evolution (cc/g) |
| Comparative | — | — | 1.30 |
| example 1 | | | |
| Comparative | 5 | 0.63 | 1.33 |
| example 2 | | | |
| Comparative | 12 | 0.73 | 1.31 |
| example 3 | | | |
| Comparative | 11 | 0.18 | 1.17 |
| example 4 | | | |
| Comparative | 3 | 0.87 | 1.08 |
| example 5 | | | |
| Example 2 | 12 | 0.85 | 0.92 |
| Example 3 | 32 | 0.99 | 0.86 |
| Example 1 | 46 | 0.89 | 0.80 |
| Example 4 | 52 | 0.93 | 0.72 |
| Example 5 | 75 | 0.90 | 0.69 |

The amount of gas evolution was small in the batteries according to the examples. The use of the second particles with the particular sphericity and specific surface area decreased gas evolution. By contrast, the amount of gas evolution was large in the batteries according to the comparative examples.

### Examples 6 to 9

Non-aqueous electrolyte secondary batteries were manufactured and subjected to the evaluation in the same manner as in Example 1 except that the second particle content (per 100 parts by mass of the first particles) was changed as shown in Table 2. Table 2 shows the evaluation results.

TABLE 2

| | Second particle | Specific surface | Sphericity | Amount |
|---|---|---|---|---|
| | content (parts by | area of second | of second | of gas |
| | mass) | particle (m²/g) | particle | evolution (cc/g) |
| Comparative | — | — | — | 1.30 |
| example 1 | | | | |
| Example 6 | 0.01 | 46 | 0.89 | 1.03 |
| Example 1 | 0.03 | 46 | 0.89 | 0.80 |
| Example 7 | 0.06 | 46 | 0.89 | 0.81 |
| Example 8 | 0.30 | 46 | 0.89 | 0.88 |
| Example 9 | 0.50 | 46 | 0.89 | 0.87 |

In the batteries according to Examples 1 and 7 to 9, in which the second particle content was 0.03 parts or more by mass per 100 parts by mass of the first particles, the gas evolution was particularly decreased.

### INDUSTRIAL APPLICABILITY

A non-aqueous electrolyte secondary battery according to the present invention is useful as a main power supply in mobile communication devices, portable electronic devices, and the like.

### REFERENCE SIGNS LIST

4 frame
5 sealing plate
6 battery case
9 electrode assembly
11 negative-electrode lead
13 negative-electrode terminal
14 positive-electrode lead

1. A positive electrode for a non-aqueous electrolyte secondary battery, comprising:
a first particle and a second particle,
wherein the first particle is an electrochemically active positive-electrode active material,
the positive-electrode active material contains a lithium transition metal oxide,
the second particle is an electrochemically inactive metal oxide,
the second particle has a BET specific surface area in the range of 10 to 100 m²/g, and
the second particle has a sphericity of 0.8 or more.

2. The positive electrode for a non-aqueous electrolyte secondary battery according to claim 1, wherein the lithium transition metal oxide and the metal oxide contain the same transition metal as a main component.

3. The positive electrode for a non-aqueous electrolyte secondary battery according to claim 1, wherein the lithium transition metal oxide contains Ni.

4. The positive electrode for a non-aqueous electrolyte secondary battery according to claim 1, wherein the metal oxide contains Ni.

5. The positive electrode for a non-aqueous electrolyte secondary battery according to claim 1, wherein an average particle size P1 of the first particles and an average particle size P2 of the second particles satisfy the following relational expression
0.8≤P2/P1≤1.2.

6. The positive electrode for a non-aqueous electrolyte secondary battery according to claim 1, wherein the first particles have an average particle size P1 in the range of 2 to 30 μm.

7. The positive electrode for a non-aqueous electrolyte secondary battery according to claim 1, wherein the second particles have an average particle size P2 in the range of 2 to 35 μm.

8. The positive electrode for a non-aqueous electrolyte secondary battery according to claim 1, wherein the positive electrode contains 0.03 to 0.3 parts by mass of the second particles per 100 parts by mass of the first particles.

9. A non-aqueous electrolyte secondary battery comprising: the positive electrode according to claim 1; a negative electrode; and a non-aqueous electrolyte.
